(19) United States
(12) Patent Application Publication
(10) Pub. No.: US 2011/0257988 A1
(43) Pub. Date: Oct. 20, 2011

(54) MULTI-PHASE ANCHOR-BASED DIAGNOSTIC DECISION-SUPPORT METHOD AND SYSTEM

(75) Inventors: Yaron DENEKAMP, Haifa (IL); Mor Peleg, Haifa (IL)

(73) Assignees: CARMEL-HAIFA UNIVERSITY ECONOMIC CORP. LTD., Mount Carmel (IL); MOR RESEARCH APPLICATIONS LTD., Tel Aviv (IL)

(21) Appl. No.: 12/760,142

(22) Filed: Apr. 14, 2010

(51) Int. Cl. G06Q 50/00; G06N 5/02

(52) U.S. Cl. 705/2; 706/59; 706/54

(57) ABSTRACT

A medical diagnosis decision support system for assisting a health professional to diagnose a medical condition. The system is first provided with an anchor condition that can be a symptom, a sign, a laboratory test result, or an imaging test results or any combination thereof The system then guides users in a series of predetermined phases regarding abstract or concrete diagnosis groups that should be considered and appropriate data that should be collected during the clinical investigation process. The system suggests history and physical examination clinical data items, laboratory, and imaging tests that should be collected in order to differentiate among alternative diagnoses. In each phase, possible diagnoses are listed and ranked.

### TECHNICAL FIELD

The present invention relates to decision support systems in general, and in particular to medical diagnosis systems.

### BACKGROUND ART

A medical diagnosis process is a complex cognitive process comprising a variety of different types of problem solving tasks that are involved in the clinical reasoning process. In addition, physicians must follow progress in clinical research and incorporate ever growing new knowledge regarding diagnosis of clinical problems and diseases. Clinical Decision Support Systems (DSSs) have been recognized as important tools to aid clinicians in gathering relevant knowledge and data, making clinical decisions, managing medical actions more effectively, and thus achieving reduced practice errors, a higher standard of care, and reduced costs. Clinical DSSs can provide tools for information management (e.g., retrieval and storage), for focusing attention (e.g., alerts and reminders), and for providing patient-specific recommendations. Diagnostic DSSs assist a clinician with one or more component steps of the clinical diagnostic process.

Currently, relatively few diagnostic DSS are being used and the rate of usage in routine clinical practice is considered low. Part of the difficulty experienced in incorporating them may be associated with the lack of integration into the clinical reasoning process involved in clinical diagnosis.

In essentially all of the present diagnostic DSSs, the user enters data about symptoms, signs, and laboratory test results, and the DSS produces a list of possible diagnoses. These DSSs help the user in selecting controlled vocabulary terms to describe the findings. Some systems may guide the user with the diagnostic process, incorporating rule-in and rule-out diagnostic processes depending on the scores of the hypotheses in the Differential-Diagnosis set (DD-set). Other systems may offer decision-support services that the user can invoke, such as providing a disease profile, focusing the diagnosis on important features, viewing evidence for a diagnosis, and obtaining explanations of findings. Most of the existing diagnostic DSSs are used by novice clinicians, or by experienced clinicians to aid them in diagnosing difficult cases.

Available probabilistic diagnostic DSSs today are not specially tailored toward assisting expert and non-expert physicians in the proper and efficient workup of a clinical manifestation which may be a symptom, sign, abnormal laboratory or imaging test results, or any combination of these.

Developing diagnostic DSSs that cover large domains poses great challenges including:

(1) Acquiring the clinical knowledge and keeping it up to date. Knowledge can be acquired by eliciting it from domain experts or it can be gathered from the literature or by compiling data found in electronic medical record systems.

(2) Representing and reasoning with the clinical knowledge. The main decision-support models are quantitative (e.g., statistical models including Bayesian Networks, machine learning approaches) or qualitative (e.g., heuristic knowledge represented as rules, ontologies, or decision tables).

(3) Supporting the sequence of reasoning used in the diagnosis process.

(4) Integrating with controlled vocabularies and clinical information systems.

(5) Supporting system evolution, including evaluation, testing, and quality control.

(6) Addressing legal and ethical issues.

### Available Diagnostic Decision-Support Systems for Broad Medical Domains

The “Leeds abdominal pain system” [de Dombal FT. Computer-aided diagnosis and decision-making in the acute abdomen. J R Coll Physicians Lond 1975; 9(3):211-8] was the first diagnostic DSS, published in 1972. Since then, a number of computer-based systems with diagnostic capabilities have been developed for broad ranges of diseases. Examples include Dxplain [Barnett G O, Famiglietti K T, Kim R J, Hoffer E P, Feldman M J. DXplain on the Internet. Proc AMIA Symp 1998: 607-11], Iliad [Lincoln M J, Turner C W, Haug P J, Warner H R, Williamson J W, Bouhaddou O, et al. Iliad training enhances medical students' diagnostic skills. J Med Syst 1991; 15(1):93-110], Meditel [Waxman H S, Worley W E. Computer-assisted adult medical diagnosis: subject review and evaluation of a new microcomputer-based system. Medicine (Baltimore) 1990; 69(3):125-36.], Quick Medical Reference (QMR) [Miller R, Masarie F E, Myers J D. Quick Medical Reference (QMR) for diagnostic assistance. MD Comput 1986; 3(5):34-48], Problem Knowledge Coupler (PKC) [Weed L L, Hertzberg R Y. The use and construction of problem-knowledge couplers, the knowledge coupler editor, knowledge networks, and the problem-oriented medical record for the microcomputer. Proc Symp Comp Appl Med Care 1983:831-6], Isabel [Ramnarayan P, Kulkarni G, Tomlinson A, Britto J. ISABEL: a novel Internet delivered clinical decision support system. In: Bryant J, editor. Current perspectives in healthcare computing. Harrogate, UK; 2004. p. 245-54], Physician Assistant Artificial Intelligence Reference System (PAIRS) [Logic Medical Systems. PAIRS (Physician Assistant Artificial Intelligence Reference System); 2007. Available from: http://cyberdoc.freewebspace.com/, last accessed Jun. 25, 2009] (previously known as QMR-DT [Shwe M, Cooper G. An empirical analysis of likelihood-weighting simulation on a large, multiply-connected medical belief network. Comput Biomed Res 1991; 24(5):453-75]), and Global Infectious Diseases and Epidemiology Network (GIDEON) [Edberg S C. Global Infectious Diseases and Epidemiology Network (GIDEON): a world wide Web-based program for diagnosis and informatics in infectious diseases. Clin Infect Dis 2005; 40(1):123-6]. These systems differ in the data used to determine their probability estimates, the extent to which diseases and related clinical data are addressed in their knowledge bases, the particular vocabulary they require to describe clinical data, and the computational model they use to combine and analyze data, as shown in Table 1 and described in detail below.

TABLE 1
Characteristics of diagnostic DSS's currently available

| | | | | | | | Problem | |
|---|---|---|---|---|---|---|---|---|
| | | | | | QMR-DT | | Knowledge | The DSS of |
| | QMR | DXplain | Iliad | GIDEON | (PAIRS) | Isabel | Coupler | the invention |
| Sources of | Literature | Literature | Literature | Literature | Literature | Literature | Literature | Literature |
| knowledge | and experts | and experts | | | | | | and experts |
| Main Clinical | − | − | − | − | − | − | + | + |
| Manifestation | | | | | | | | |
| (MCM)-oriented | | | | | | | | |
| DD shown at | + | + | + | + | + | + | Can be | + |
| each stage | | | | | | | requested | |
| Advice on | +/−Advice is | + | + | − | − | − | + | + |
| data/tests that | not actively | | | | | Collection | | |
| should be | offered. Users | | | | | of text | | |
| collected | can invoke | | | | | material | | |
| | menu option | | | | | indexed | | |
| | for ruling-in | | | | | with the | | |
| | and ruling-out | | | | | disease | | |
| | diagnoses | | | | | concepts | | |
| | | | | | | is | | |
| | | | | | | accessible | | |
| Representation | − | − | − | + | − | − | − | + |
| of temporal | | | | | | | | |
| relationships | | | | | | | | |
| between data | | | | | | | | |
| items | | | | | | | | |
| Synergism | − | − | + | + | + | − | − | + |
| between data | | | | | | | | |
| items | | | | | | | | |
| Probabilistic | + | + | | + | | − | − | + |
| ranking of the | | | | | | | | |
| diseases | | | | | | | | |
| Consideration of | − | − | − | − | − | − | − | + |
| doctor's clinical | | | | | | | | |
| reasoning, in | | | | | | | | |
| which clinical | | | | | | | | |
| investigation is | | | | | | | | |
| done in stages of | | | | | | | | |
| decreasing | | | | | | | | |
| abstraction | | | | | | | | |
| Local adaptation | − | +some | − | + | − | − | possible | + |
| of system | | support | | | | | | |
| Ability of user to | + | + | − | − | − | − | + | + |
| override system | | | | | | | | |
| recommendations, | | | | | | | | |
| selecting a | | | | | | | | |
| different DD set | | | | | | | | |
| Consideration of | + | +Rare | + | + | + | + | Only relevant | Only relevant |
| all hypotheses | | disease | | | | | diagnoses are | diagnoses are |
| | | displayed | | | | | listed | listed |
| | | separately | | | | | | |
| Scope of | Diseases | Diseases | Diseases | Diseases | Diseases | Diseases | Knowledge | Knowledge |
| knowledge | and | and | and | and | and | and | relevant | relevant |
| | findings | findings | findings | findings | findings | findings | for MCM | for MCM |
| | for | for | for | for | for | for | | |
| | internal | internal | internal | Infectious | internal | internal | | |
| | medicine | medicine | medicine | diseases | medicine | medicine, | | |
| | | | | | | pediatrics, | | |
| | | | | | | geriatrics | | |
| Explanations | +what | +what | + | + | − | − | References to | + |
| provided | findings | findings | | | | | literature | |
| | support a | support a | | | | | may be | |
| | diagnosis | diagnosis | | | | | provided | |
| Computational | Disease/ | Disease/ | Bayes + | Bayes | Bayes | Pattern- | Disease/finding | Multi phase, |
| model | finding | finding | decision | | | matching | Relationships; | anchor based, |
| | Relationships | Relationships | rules | | | algorithms | predecessor/ | relational or |
| | | | | | | | successor | between |
| | | | | | | | relations | Bayesian |
| | | | | | | | entities. No | |
| | | | | | | | ranking of disease | |
| | | | | | | | hypotheses | |

* Focusing the diagnosis on selected findings is possible

In terms of the computational model, Iliad, Meditel, PAIRS, and GIDEON are based on Bayes' theorem; for example, the differential diagnosis list in GIDEON is based on a Bayesian formula that compares the mathematical product of disease incidence times the rate of symptom occurrence for all relevant infectious diseases within a given country. In addition to using Bayes theorem, Iliad also uses decision rules for reasoning with clusters of conditionally-independent findings. This is meant to solve the problem of over confident, unreliable diagnostic results that occurred because findings were not completely independent.

Isabel uses pattern-matching algorithms to compare findings entered by a user to terms used in a selected reference library that includes text from medical books and journals. By collating text related to one specific diagnosis under a single diagnostic label within a pre-designed diagnostic tree, it was possible for the software to generate a unique signature of key concepts for each diagnosis.

DXplain and QMR (and QMR's predecessor, Internist-1) use non-Bayesian algorithms that focus on a relational model describing relationships between case findings (symptoms, signs, laboratory data) and individual diseases to derive a weighted assessment of a patient's clinical presentation. In Internist-1 [Miller R A, Pople H E, Myers J D. Internist-1, an experimental computer-based diagnostic consultant for general internal medicine. N Engl J Med 1982; 307(8):468-76] as well as in QMR and DXplain, one type of disease-finding relationship represents the frequency with which the finding occurs in the disease, and the other the degree to which the presence of the finding suggests consideration of the disease (evoking strength). Other tables store the importance of explaining findings, disease frequencies (prevalence) and disease importance (impact of not considering the disease if it is present). The DXplain algorithm also considers the number of diseases in the Differential-Diagnosis set (DD-set).

Problem Knowledge Coupler (PKC) takes a philosophical stand that the assesser should understand the pattern of findings (and test results) occurring for her patient gather relevant knowledge, in the other systems the knowledge from the literature is incorporated into the knowledge base manually.

All of the diagnostic DSSs can aid a physician during his clinical reasoning process. They all allow the user to start the diagnosis process with patient findings, but out of the systems surveyed in Table 1, only Iliad, DXplain, and PKC provide advice on data that should be collected and laboratory tests that should be employed. In PKC, the sequence of data that should be collected is represented in the system's model ahead of time.

GIDEON is the only system that explicitly represents temporal relationships between data items. All the systems that use a Bayesian computational model can support synergistic effects between findings, i.e., findings that together suggest a diagnosis with a higher probability. GIDEON, and to some extent also DXplain, consider the geographical location of the patient as a factor in the diagnostic process. When findings are entered, all possible diagnoses that cover those findings are considered in all of the DSS, but disease prevalence is taken into account for ranking the possible diagnoses.

In DXplain, rare diseases are displayed separately. The different diagnostic DSSs all provide explanations for why each of these diseases might be considered. DXplain also lists the clinical manifestations, if any, which would be unusual or atypical for each of the specific diseases and GIDEON also explains why other diagnoses are not considered. In Isabel, the explanations are in the form of linking with up to date knowledge from textbooks and journals. However, none of the diagnostic DSSs currently in use offer pathophysiological reasoning that create models of a specific patient's illness.

### Hypothetico-Deductive Reasoning and Main Clinical Manifestation-Oriented Diagnosis

Several cognitive models of clinical diagnostic reasoning processes have been developed. Some of the highly-accepted models view the diagnostic process as either hypothesis formulation or pattern recognition [Elstein A S, Schwartz A. Chapter 10: clinical reasoning in medicine. In: Higgs J, Jones M A, editors. Clinical reasoning in the health professions. Butterworth-Heinemann; 2000]. Hypothetico-deductive reasoning [Shortliffe E H, Barnett G O. Chapter 2: biomedical data: their acquisition, storage, and use. In: Shortliffe E H, Cimino J J, editors. Biomedical informatics: computer applications in health care and biomedicine. Springer; 2006] is an iterative process, which involves staged data collection followed by data interpretation and the generation of a set of hypotheses (which in the case of clinical diagnosis is known as the DD-set), leading to hypothesis-directed selection of the next most appropriate data to be collected. The data collected at each stage are used to reformulate or refine the active hypotheses. The reasoning process is iterated until one hypothesis reaches a threshold level of certainty. The staged-process helps to focus the reasoning process. When physicians have collected initial data from the patients' history and physical examination, they can generate an initial DD-set. By that time, physicians have expectations of what they will find on further examination or may have specific tests in mind that will help them to distinguish among still active hypotheses.

A clinical investigation usually starts from some clinical anchor finding. Many times, this clinical anchor is the reason for patients to seek medical care as well as for physicians to initiate an investigation. This anchor is referred to herein as a Main Clinical Manifestation (MCM), which may consist of a single clinical problem such as, diarrhea, syncope, or jaundice, laboratory test result (e.g., hyponatermia), or combinations of several linked findings, such as fever and rash (which is a common clinical manifestation in pediatrics). The MCM plays an important role in focusing the diagnostic process. This is in concert with the findings of Eddy and Clanton [Eddy D M, Clanton C H. The art of diagnosis: solving the clinicopathological conference. N Engl J Med 1982; 306(21):1263-9] who showed that identification of a pivotal finding is often used to simplify the diagnostic problem and to narrow the focus to a limited set of hypotheses. During the clinical reasoning process, when doctors consider the various possible diagnoses that explain the MCM they take into account the probability of each diagnosis to be manifested as the MCM, ranking diagnoses that are more likely to be manifested as the MCM higher.

During the diagnostic process, physicians collect and analyze several types of data types, including subjective information acquired by questioning the patient (i.e., symptoms or medical history), objective findings obtained by performing physical examination (i.e., signs) and all sorts of laboratorial and imaging data. At any point in this process, there are several diagnoses that might fit the data collected (i.e., differential diagnosis). Their number should decrease as the diagnostic process progresses. As has already been shown years ago, expert clinicians can make a diagnosis in the majority of patients using the history and physical examination data alone [Hampton J R, Harrison M J, Mitchell J R, Prichard J S, Seymour C. Relative contributions of history-taking, physical examination, and laboratory investigation to diagnosis and management of medical outpatients. Br Med J 1975; 31(2(5969)):486-9; Peterson M, Holbrook J H, Hales D V, Smith N L, Staker L V. Contributions of the history, physical examination, and laboratory investigation in making medical diagnoses. West J Med 1992; 156(2):163-5].

MCM-oriented diagnosis is a well-accepted approach in clinical diagnosis. It is evident in medical books [Behrman R E, Kliegman R M, Jenson H B. Nelson textbook of pediatrics. 17^{th} ed. Elsevier; 2004; Fauci A S, Braunwald E, Kasper D L, Hauser S L. Harrison's principles of internal medicine. 17th ed. McGraw-Hill Professional; 2008] (e.g., diagnosing fever and rash in children). Traditionally, text books often did not report evidence-based (EB) statistics regarding disease prevalence per clinical problem or frequency of clinical data items given a disease. Medical books based on the principles of evidence-based MCM-oriented diagnosis that report such data are becoming more prevalent.

There is thus a great need for diagnostic DSSs that would support the investigation process of clinical problems.

### SUMMARY OF INVENTION

It is an object of the present invention to provide a medical diagnostic decision-support system.

It is another object of the present invention to provide a medical diagnostic decision-support system that is MCM-oriented.

It is a further object of the present invention to provide a medical diagnostic decision-support system that is MCM-oriented and supports a diagnostic process that is conducted in phases of decreasing abstraction.

The present invention thus relates to diagnostic DSS that assists physicians in the process of MCM-oriented diagnosis. The invention emphasizes proper workup of a presenting symptom, sign, abnormal test result or a combination of these and supports a hypothetico-deductive diagnostic process. The invention integrates several notions in a novel way resulting in a multi-phase, anchor-based information model that uses abstract diagnosis groups. This multi-phase approach, which revolves upon an anchor finding per each phase, enables efficiency in conducting the diagnostic process using a minimal effective set of clinical data items (CDIs) in each phase.

The DSS of the invention provides decision support for MCM-oriented diagnosis meant to support expert and non-expert physicians in the process of investigating clinical problems in all fields of medicine.

In a broader sense, the invention can be applied to any DSS, including DSSs outside the medical field, wherein the different possible solutions to a problem can be investigated in predetermined phases. Each phase is characterized by an anchor that is investigated.

The present invention thus relates to a computerized medical diagnosis method for assisting a health professional to diagnose a medical condition, comprising the steps of:

(i) providing an anchor condition;

(ii) associating with the anchor condition a plurality of diagnoses whose main clinical manifestation is the anchor condition;

(iii) associating with each diagnosis of the plurality of diagnoses a weight that represents the likelihood that the diagnosis is manifested as the anchor condition;

(iv) associating a plurality Clinical Data Items (CDIs) with each diagnosis of the plurality of diagnoses given the anchor condition, each combination of CDI and a diagnosis is assigned a true, false or unknown value, wherein a true value represents an evoking strength in which the CDI evokes the diagnosis and a false value represents a penalty that the diagnosis receives if the CDI is not present in a patient;

(v) calculating a total weighted score for each diagnosis among the plurality of diagnoses by adding for each diagnosis: the likelihood that the diagnosis is manifested as the anchor, the evoking strengths of each CDI that is true for the patient and for which a relationships of CDI evokes diagnosis exists and subtracting for each CDI that is absent in the patient the penalty weight for defined penalty relationships between the diagnosis and the CDIs;

(vi) choosing a diagnosis above a cutoff level of the weighted score and making it an anchor condition; and

(vii) repeating steps (ii) through (vi) until the diagnosis with the highest weighted score does not have any associated diagnoses and is thus determined to be the diagnosis for the medical condition.

In certain embodiments of the present invention, the anchor condition is a symptom, a sign, a laboratory test result, an imaging test results or any combination thereof

In certain embodiments of the present invention, the DSS of the invention suggests clinical data items, laboratory, and imaging tests that should be collected in order to differentiate among alternative diagnoses.

In certain embodiments of the present invention, possible diagnoses of the medical condition are listed and ranked.

In certain embodiments of the present invention, a knowledge base for medical conditions and their associated main clinical manifestations is created.

In certain embodiments of the present invention, the probability of occurrence of a MCM given a disease is indicated.

In certain embodiments of the present invention, a user can override a recommended diagnosis above the cutoff level of the weighted score and select instead a different diagnosis and make it an anchor condition.

### BRIEF DESCRIPTION OF DRAWINGS

FIG. 1 shows an instance of the Anchor class, as modeled using the Protege-2000 modeling tool.

FIGS. 2A-2B are screenshots showing the specification of an anchor, namly Fever. FIG. 2A shows how Fever is a required CDI for the anchor of acute diarrhea, which is collected during the physical exam. FIG. 2B shows the allowed value type of this CDI: temperature. Temperature is an instance of Categorical_Value. The categories of temperature are low or high.

FIG. 3 shows an Entity-Relationship Diagram showing the information model of the three relationships used to define an Anchor. Concepts are shown as rectangles and relationships as diamonds. Multi-cardinality relationships are marked with n, m, p, and r.

FIG. 4 is a screenshot showing a definition of a temporal synergistic relationship between a pair of CDIs that evokes a diagnosis in a given anchor. The evoking strength is specified by the slot “weight”, whose range is 1-10. The figure shows that when the anchor is infections diarrhea, then the occurrence of ingestion of specific food 3 h (±3 h) before the onset of diarrhea suggests, with weight 10, the diagnosis of toxin-borne diarrhea. But, when ingestion of suspicious food is not present in the patient, 9 points are penalized from the diagnosis of toxin-borne diarrhea.

FIG. 5 is a pseudo-code for the diagnoses scoring algorithm given an anchor.

FIG. 6 shows the scores of the hypotheses defined in the DD-set of the current phase of the algorithm, shown in FIG. 1. Numbers appearing in italics (the first number in each row) are based on the Diagnosis_manifested_as_anchor relationship. Numbers appearing in regular font are based on the CDI_evokes_Diagnosis relationships (evoking strengths and penalties). The scores of the Dxs that are above the cutoff are shown in bold.

FIG. 7 shows Bayesian Networks (BN) for the three phases of diagnosis of diarrhea derived from the knowledge represented in Table 2 with uniform prior probabilities of disease hypotheses.

FIG. 8 shows a diagnostic knowledge for the anchor diarrhea.

FIG. 9 shows a diagnostic knowledge for the anchor acute diarrhea.

FIG. 10 shows a diagnostic knowledge for the anchor infectious diarrhea.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

A Main Clinical Manifestation (MCM)-oriented diagnosis is a problem-oriented process that starts with a chief clinical problem, reasons about possible diagnoses that would be manifested as the MCM, and suggests the clinical data items, laboratory, and imaging tests that should be collected in order to differentiate among alternative diagnoses. The MCM-oriented reasoning process is typically conducted in phases. At the initial phases, the differential is sometimes between diagnosis groups that are meaningful in the context of the diagnostic process, for example, chronic vs. acute diarrhea or infectious vs. noninfectious diarrhea. Such diagnosis groups are referred to as abstract diagnoses. As the diagnostic process advances, the differential is between actual diagnoses. Such phased problem-oriented processes are used for many clinical problems (e.g., syncope, jaundice), as seen in the classical clinical textbooks and in some specific medical books and evidence-based clinical practice guidelines [Tierney L M, Henderson M. The patient history: evidence-based approach. McGraw-Hill Medical; 2005; Denekamp Y, Nasreldeen O, Peleg M. Characterization of the knowledge contained in diagnostic problem oriented clinical practice guidelines. Proc AMIA Symp 2007:929].

The process of clinical investigation of clinical problems is complex and requires using and analyzing a wide relevant set of clinical data items in a systematic organized way. Physicians are expected to properly handle a wide range of clinical problem investigations. Yet incomplete workup was found to be a major source of quality of care problems [Balla U, Malnick S, Schattner A. Early readmissions to the department of medicine as a screening tool for monitoring quality of care problems. Medicine (Baltimore) 2008; 87(5):294-300]. DSS can aid physicians to manage the investigations, avoiding unnecessary referrals, unnecessary costly tests, or diagnostic errors, by empowering them with updated knowledge, evidence-based when possible. Representing and delivering such knowledge can help overcome diagnostic errors that are due to cognitive biases, such as ‘confirmation bias’, ‘outcome bias’, or ‘overconfidence bias’ [Croskerry P. The importance of cognitive errors in diagnosis and strategies to minimize them. Acad Med 2003; 78(8):775-80].

The invention provides a computerized, MCM-based, medical diagnostic DSS that relies on evidence-based clinical knowledge whenever available. It is important to assess the availability of evidence-based (EB) sources, such as clinical practice guidelines, for aiding MCM-oriented clinical diagnosis utilizing primarily data types found during history and physical examination. To determine the extent at which clinical guidelines follow MCM-oriented diagnosis and report EB statistics, a study was conducted [Denekamp Y, Nasreldeen O, Peleg M. Characterization of the knowledge contained in diagnostic problem oriented clinical practice guidelines. Proc AMIA Symp 2007: 929] of diagnostic guidelines that were archived in the National Guideline Clearinghouse (NGC) web site (www.ngc.gov)—a public resource for evidence-based clinical practice guidelines, initiated and maintained by the Agency for Healthcare Research and Quality and the US Department of Health and Human Services. Filtering features were employed, provided by NGC's website to consider only the potential diagnostic guidelines (1182 guidelines, at the time of the study). Each guideline was then manually inspected, and it was found that 146 of the guidelines indeed addressed diagnosis that starts with a MCM. After characterizing 25% of these guidelines, we found little use of quantitative statistical data, such as frequency of manifestation of findings in given diseases and disease prevalence, for determining diagnosis. That trend found in the study, which was done in 2007, was also observed in an updated study that we recently summarized. In addition, it was found that many of the guidelines make use of disease categories i.e., abstract diagnoses rather than just individual diagnoses. Some guidelines reported temporal and synergistic relationships between patient findings, which serve as important knowledge for diagnosis.

These findings suggest that although MCM-oriented diagnosis is a well accepted diagnostic approach, MCM-oriented guidelines that report evidence-based statistical data are not very common, necessitating the elicitation of such data from other sources, such as experts or from statistical clinical databases.

The MCM-oriented approach of the invention uses the following six notions:

(1) MCM-Oriented Diagnosis

The medical diagnosis DSS of the invention enables MCM-oriented diagnosis and emphasizes the use of clinical data items from the history and physical examination; a MCM is any CDI or a combination of CDIs that can be a symptom, sign, laboratory or other test, which is the starting point of the diagnosis process. Unlike other DSSs, in the invention the MCM is treated as being more important than other findings and plays a crucial role at focusing the diagnostic process. The invention does not associate every disease with every finding, as done in diagnostic DSS for broad domains, nor does it represent its knowledge as a network of interconnected frames of diseases and clinical states from which disease hypotheses are selected, based on findings exhibited by the patient, as done in the Present Illness program. The invention considers and ranks for each MCM only the set of diagnoses whose main clinical manifestation is the MCM, as reported in evidence-based (EB) sources or medical literature that discuss problem-oriented diagnosis. This is expected to enable more efficiency and accuracy in scoring the different diagnosis hypotheses that are evoked by the MCM. For example, if the MCM is hyponatremia (low level of sodium), then for the DSS of the invention, pneumonia will not be part of the DD-set as it is in some other models. This is because although hyponateremia can be found in pneumonia, it will never be the main clinical manifestation of pneumonia; a patient with pneumonia will exhibit other findings (e.g., fever, cough, rapid breathing, etc.) that will focus the clinician on pneumonia.

(2) Phases

The DSS of the invention presents a new approach by supporting a diagnostic process that is carried out in predetermined phases. The DSS supports phases by structuring the process of DD reduction as a predetermined tree of hierarchical DDs, which are referred to as DD-tree. Each layer of the tree corresponds to a diagnostic phase (e.g., acute diarrhea, infectious diarrhea), mimicking the clinician's hypothetico-deductive reasoning process of diagnosis that is used during problem-oriented diagnosis. At the beginning of the diagnostic process, the focus (anchor) of the diagnosis is the MCM (e.g., diarrhea, jaundice, syncope) that triggered the diagnostic process, and serves as the root of the tree. For this anchor, a set of diagnoses that can be abstract and relevant clinical data items for making a diagnosis are defined. As shown in Table 2(a) for the diarrhea anchor, a set of two abstract diagnoses are provided in phase 1: acute vs. chronic diarrhea. To differentiate between them, the DSS uses the CDIs: “duration of diarrhea ≦14 days” and “duration >14 days”, which, per definition, are considered pathognomonic (i.e., unambiguously characteristic of a particular disease) for discriminating between these two alternatives. As the diagnostic process advances through the levels of the diagnostic tree, the DD-set becomes more and more specific. For example, if in phase 1, the selected alternative was acute diarrhea, then, as shown in Table 2(b), acute diarrhea serves as the anchor for phase 2. Phase 2 includes five alternatives, including infectious diarrhea, medication change, inflammatory bowel disease, intermittent bowel obstruction, and colonic ischemia. To differentiate among these hypotheses the DSS uses a collection of CDIs that are relevant for that phase, as shown in the second row of Table 2(b) and the user enters values to indicate whether these CDIs are present in the patient. The strengths/probabilities of relationships between disease hypotheses and CDIs in each phase are indicated as numbers in the table, as explained below. Based on the CDIs values for the patient, an algorithm (heuristic or Bayesian) ranks the diseases in the DD-set and sets the highest ranking disease as the new anchor for the next phase.

TABLE 2
A set of three tables showing a path in the DD-tree. Each table represents a differnet layer (phase) in the tree.
The second column shows the disease manifested as anchor relationship data. The other cells in the tables show evoking
strengths and penalties (penalties are shown in parentheses) for diagnoses given an anchor. The anchor is diarrhea in
phase 1, acute diarrhea in phase 2, and infectious diarrhea in phase 3. The numbers in the table (b) were elicited from experts
and the numbers from tables (a) and (c) were elicited from EB sources.

| (a) Phase 1 anchor: | | | |
|---|---|---|---|
| diarrhea | | CDI | |
| | Dx manifested | | |
| Diagnosis | as diarrhea | Duration ≦14 days | Duration >14 days |
| Acute | | pathognomonic | |
| Diarrhea | | | |
| Chronic | | | pathognomonic |
| Diarrhea | | | |

| (b) Phase 2 anchor: | | | | | | | |
|---|---|---|---|---|---|---|---|
| acute diarrhea | | CDI | | | | | |
| | Dx manifested | | | | | | More |
| | as acute | High | Abrupt | Nausea/ | | | people |
| Diagnosis | diarrhea | fever | presentation | vomiting | Mucus | Arthritis | developed |
| Infectious | 16 | 9 | 9 | 8 | 1 | | 9 |
| Diarrhea | | | | | | | |
| Medication | 8 | | 7 | 3 | | | |
| change | | | | | | | |
| Inflammatory | 14 | 4 | 2 | 2 | 8 | 9 | |
| Bowel Disease | | | | | | (−5) | |
| Intermittent | 10 | | 2 | 2 | | | |
| Bowel | | | | | | | |
| Obstruction | | | | | | | |
| Colonic | 8 | | 2 | 2 | | | |
| Ischemia | | | | | | | |

| (c) Phase 3anchor: | | | | | | | | | |
|---|---|---|---|---|---|---|---|---|---|
| infectious diarrhea | | CDI | | | | | | | |
| | Manifested | | | | | | | | |
| | as infectious | | Abdominal | Tenes | Nausea/ | Watery | Flu-like | Bloody | Recent |
| Diagnosis | diarrhea | Fever | pain | mus | vomit | diarrhea | symptom | stools | antibiotic |
| Shigella | | 8 (−7) | 8 | 7 (−7) | 8 | | | 4 | |
| Non-Shigella | | 7 (−5) | 7 | | 4 | | | 3 | |
| bacterial | | | | | | | | | |
| Clostridium | | 3 | 2 | | | | | | 8 (-6) |
| Parasitic | | 1 | 3 | | | | | | |
| Food-borne* | | 0 | | | | | | | |
| Viral | | 8 | 2 | | 8 | 9 | 7 (−8) | | |

*Disease-finding relationships for the food-borne diagnosis are provided in Table 3.

(3) Abstractions

As explained hereinabove, the multi-phase diagnostic process of the DSS often starts with abstract concepts, is refined in each phase, and ends in specific diagnoses. This diagnostic process that uses abstractions is valuable not only because of the efficiency of CDIs considered in each phase, but also because abstractions are often used by clinical experts during problem-solving. As discussed by Newell and Simon [Newell A, Simon H A. Human problem solving. Englewood Cliffs, N.J.: Prentice Hall; 1972], studies examining constrained problem spaces such as chess-playing have documented that experts recognize patterns of activity within a domain at an integrated, higher level (“chunking”) than novices. Abstractions have been used in diagnostic DSSs before. Abstractions have been used in the Internist-1 [Pople Jr H E. Heuristic methods for imposing structure on ill-structured problems: the structuring of medical diagnostics. In: Szolovits P, editor. Artificial intelligence in medicine. Boulder, Colo.: Westview Press; 1982.] knowledge base, which contains a hierarchy of disease categories, organized primarily around the concept of organ systems, where positive findings can evoke either individual disease nodes or higher-level nodes in the disease hierarchy. Pople suggested a reasoning model where any given disease can be classified in as many descriptive categories of the hierarchy as are appropriate.

(4) Anchor-Specific Disease-Finding Relationships

The DSS of the invention provides weighted relationships between disease and findings that are specific to the given anchor and to a given geographical location, including (a) the DD-set that is relevant and probable for the given MCM (first column in Table 2); and (b) the set of relevant findings that can distinguish among the diagnoses in the DD set (the top row in each table of the Table 2 table set). (c) the likelihood of a diagnosis to be manifested as the anchor (second column in Table 2)—a notion that is unique to the invention. This is used to rank higher diagnoses that are usually manifested as the anchor finding. For instance, for an anchor of syncope, the DD-set includes cardiac arrhythmias and pulmonary embolism, yet cardiac arrhythmias are more likely to be manifested as syncope than pulmonary embolism; (d) the evoking strength with which a finding suggests a diagnosis in the DD set (numbers in the cells of Table 2). Unlike the use of this feature in Internist-1 (where it was first introduced), QMR, DXplain, and the Present Illness program, the evoking strength in the DSS of the invention considers just the disease hypotheses that are relevant for the anchor finding (which, at the beginning of the process is the MCM); (e) the penalty that a disease hypothesis should receive in the absence of a finding (numbers given in parentheses in the cells of Table 2). Penalties are also used in other diagnostic DSSs, such as Internist-1 (where they were first introduced), QMR, DXplain, and the Present Illness program. However, in the DSS of the invention, the size of this penalty is proportional to the frequency at which the disease exhibits the finding; and (f) synergistic effect between findings that together suggest a diagnosis with greater certainty than the sum of the two is explicitly modeled (Table 3); these relationships may be temporal (e.g., fever before rash, Jaundice after fever) or not temporal, just two findings that together strengthen a diagnosis.

TABLE 3
A table for eliciting synergistic temporal relationships between
CDIs and diagnoses, for the anchor of infectious diarrhea

| | | CDI-2 | Time between | |
|---|---|---|---|---|
| Diagnosis | CDI-1 | (penalty) | two CDIs | Weight |
| Food-borne | Time of onset | Time of | 0-6 hours | 10 (−9) |
| diarrhea | of diarrhea | ingestion of | | |
| | | suspicious food | | |

(5) Computational Model

The DSS of the invention's information model can be combined with different computational models (a heuristic model and a Bayesian model) for scoring disease hypotheses. This feature was guided by the Bayesian formulation of the heuristic algorithm of QMR. Uniquely, in the DSS of the invention the Bayesian formulation is structured according to the phases of anchors used in the MCM-oriented diagnostic process. The last three relationships between disease and findings discussed above are used with the heuristic scoring algorithm, discussed in below. The Bayesian approach, also discussed below, uses prior probabilities for each disease hypothesis and conditional probabilities for each combination of finding and disease (finding frequencies).

(6) User Control

The invention's approach allows the user to follow the diagnostic process with any diagnosis in the DD-set, even if it is not the highest-ranking one. This feature is in accordance with the modern view of DSSs as providing assistance to a user who is in charge of the clinical process rather than being an authoritarian and inflexible approach towards solving the clinical task for the user. This property is important because no computer program can know all that needs to be known about the patient case, no matter how much time or effort is spent on data input into the computer system, and therefore the clinician user who directly evaluated the patient must be considered to be the definitive source of information about the patient during the entire course of any computer based consultation.

II. The DDS Information Model of the Invention

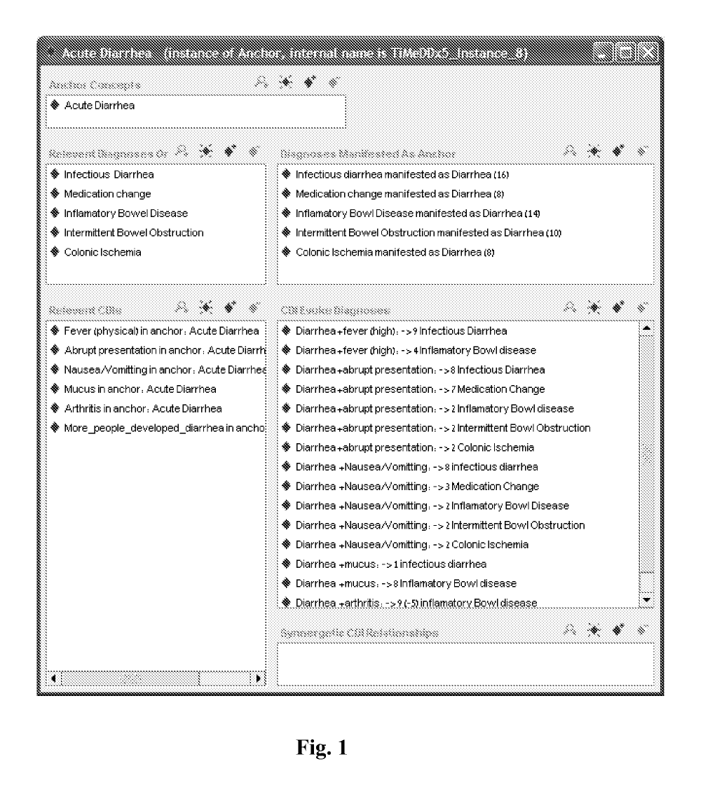

The main class in the DSS of the invention's model is Anchor, which represents the MCM in the first phase of the diagnostic process. Anchor is defined using three structural slots and three relationship slots. The relationship slots store knowledge that is used by the DSS algorithm to score diagnoses in the DD-set. FIG. 1 shows an instance of the Anchor class, as modeled using the Protege-2000 [Gennari J, Musen M A, Fergerson R W, Grosso W E, Crubezy M, Eriksson H, et al. The evolution of protege: an environment for knowledge-based systems development. Int J Hum Comput Interact 2002; 58(1):89-123] modeling tool.

Structural Slots

anchor_concepts—the concept (or concept combination, such as fever and rash) on which the DD is focused at the current diagnosis phase. In FIG. 1, the anchor concept is Acute Diarrhea.

relevant_diagnoses_or_abstractions—the relevant diagnoses for the current DD phase. At initial DD phases, abstractions are often used instead of final diagnoses.

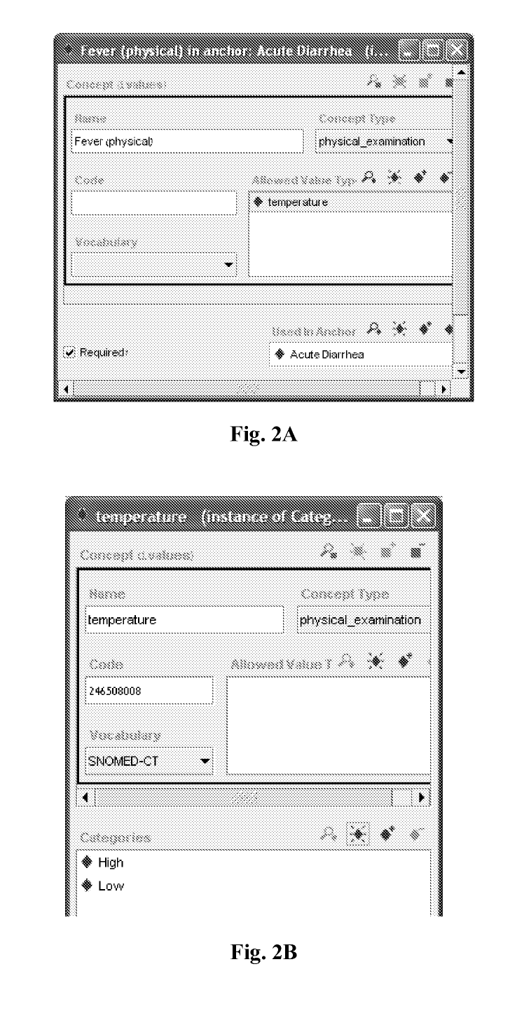

relevant_CDIs—the CDIs that should be collected in order to select the most probable diagnosis from the DD set. For each CDI the medical concept is specified and whether it is a required value for a certain phase of the DD process given a certain anchor, as shown in FIG. 2.

Relationship Slots

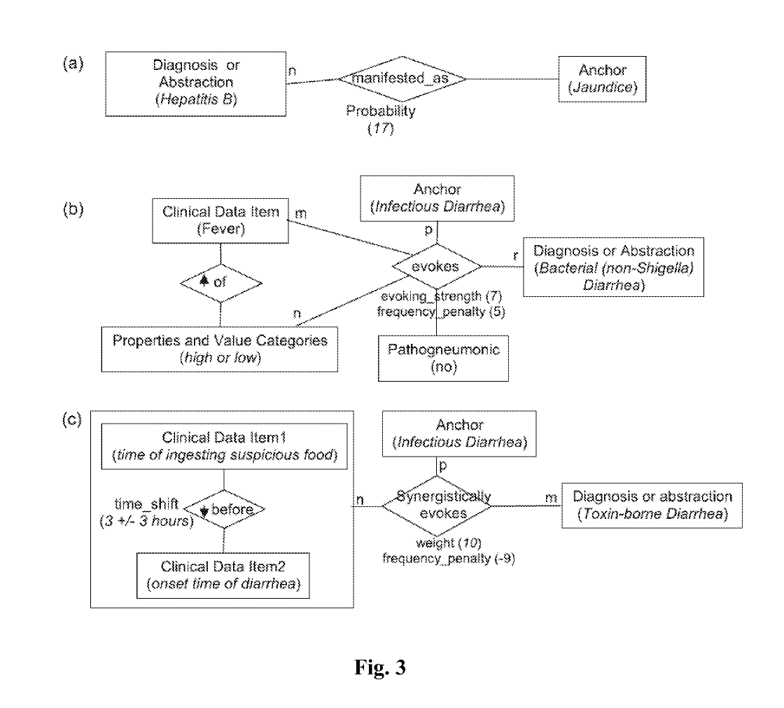

The following types of relationships relate CDIs to diagnoses. They are used by the algorithm that scores the diagnoses in the DD-set. FIG. 3 shows the information model of these three relationships, using an Entity-Relationship (ER) Diagram [Hoffer J A, George J F, Valacich J S. Modern system analysis and design. 3^{rd} ed. Prentice Hall; 2002]—where each information class is represented by an entity type (depicted as a rectangle) and relationships between information classes are represented by a relationship type (depicted as a diamond). The ER notation is used because it is widely familiar and simple and often is used to represent information models. Multi-cardinality relationships are marked with n, m, p, and r in FIG. 3. For example, (a) represents the following statement: “Anchor is manifested as n (many) Diagnoses or Abstractions”. Properties of relationships are written below the diamond symbols. Examples of entity relationships instances are provided in parentheses. The arrows mark the directionality in which the relationship should be read. (a) Diagnosis_Manifested_As_Anchor—the example shows that a diagnosis of Hepatitis B is manifested as jaundice with a probability of 17 (out of 20); (b) CDI_Evokes_Diagnosis_In_Anchor—the CDI fever with a value of high or low, in an anchor of infectious diarrhea evokes the diagnosis Bacterial (non-Shigella) diarrhea with an evoking strength of 7 (out of 10) and a frequency_penalty of 5; (c) Temporal_CDI_Relationship_Given_Diagnosis_For_Anchor—If the time of ingesting suspicious food is 3±3 h before the time of onset of diarrhea, in an anchor of Infectious Diarrhea, the diagnosis of toxin-borne diarrhea is evoked with weight of 10 (out of 10) and 9 points are penalized from that diagnosis hypothesis for the absence of ingestion of suspicious food (frequency_penalty).

diagnoses_manifested_as_anchor—bonus points are given to diagnoses that are usually manifested as the anchor concept(s). Often, the anchor concept holds a MCM that is a patient's CDI. However, the anchor may alternatively be an abstraction used in the DD (part of the DD-set), such as in the case of infectious diarrhea, which is an abstract anchor concept and not the MCM (the MCM is diarrhea). For example, cardiac arrhythmias are often manifested as syncope (anchor), but pulmonary embolism, which is in the DD-set of the syncope anchor, is usually not manifested as syncope.

CDI_evokes_Diagnosis—Like the Internist-1/QMR system, the DDS of the invention considers CDIs that suggest a diagnosis, with a certain evoking strength (1-10). As in Internist-1, frequency_penalty stores the frequency at which a finding is found in a disease; when the patient does not exhibit a CDI that is frequent in a disease hypothesis, points can be deducted from that hypothesis.

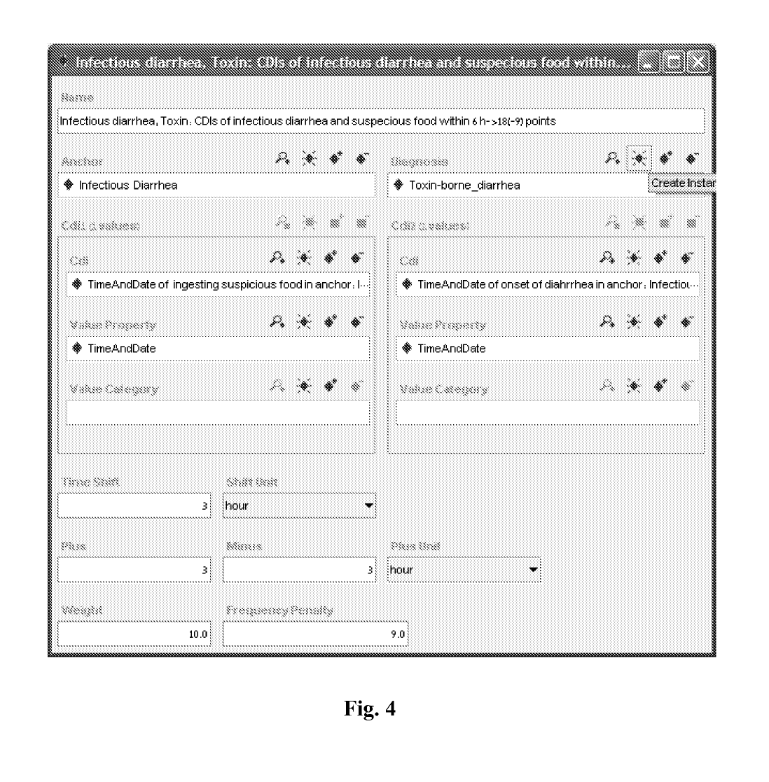

Synergistic_CDI_Relationship_Given_Diagnosis_For_Anchor—in some cases, when combinations of two (or more) CDIs occur together or in a certain temporal pattern, this suggests a certain diagnosis more probable than the additive contribution of each one of the CDIs alone. For example, if it is known that diarrhea developed less than six hours after ingesting suspicious food, it suggests the diagnosis of toxin-borne Diarrhea, based on the combination of the diarrhea and ingestion of suspicious food as CDIs, as shown in FIG. 4. FIG. 4 shows a definition of a temporal synergistic relationship between a pair of CDIs that evokes a diagnosis in a given anchor. The evoking strength is specified by the slot “weight”, whose range is 1-10. The figure shows that when the anchor is infections diarrhea, then the occurrence of ingestion of specific food 3 h (±3 h) before the onset of diarrhea suggests, with weight 10, the diagnosis of toxin-borne diarrhea. But, when ingestion of suspicious food is not present in the patient, 9 points are penalized from the diagnosis of toxin-borne diarrhea.

A Bayesian Model for Scoring Disease Hypotheses

The DDS model of the invention can be formulated in Bayesian terms with certain simplifying assumptions. As was done for the Bayesian formulation of the QMR knowledge base, it can be assumed that findings are conditionally independent given any disease hypothesis (therefore the probability of having multiple findings given a hypothesis is the product of probability of having one finding given the hypothesis, for all findings in the set of findings). Therefore, temporal synergistic relationships were converted between two findings and a disease hypothesis into one finding. As in QMR-DT, the influence of multiple diseases can be modeled on a finding assuming causal independence (i.e., the probability of a finding given only one disease is present P(F|D) instead of given combinations of diseases. In this way, all the conditional probabilities that are used in the Bayesian Networks (BNs) are of the form P(F|D), representing frequency data. It can also be assumed that only one of the alternative hypotheses would be present in a patient.

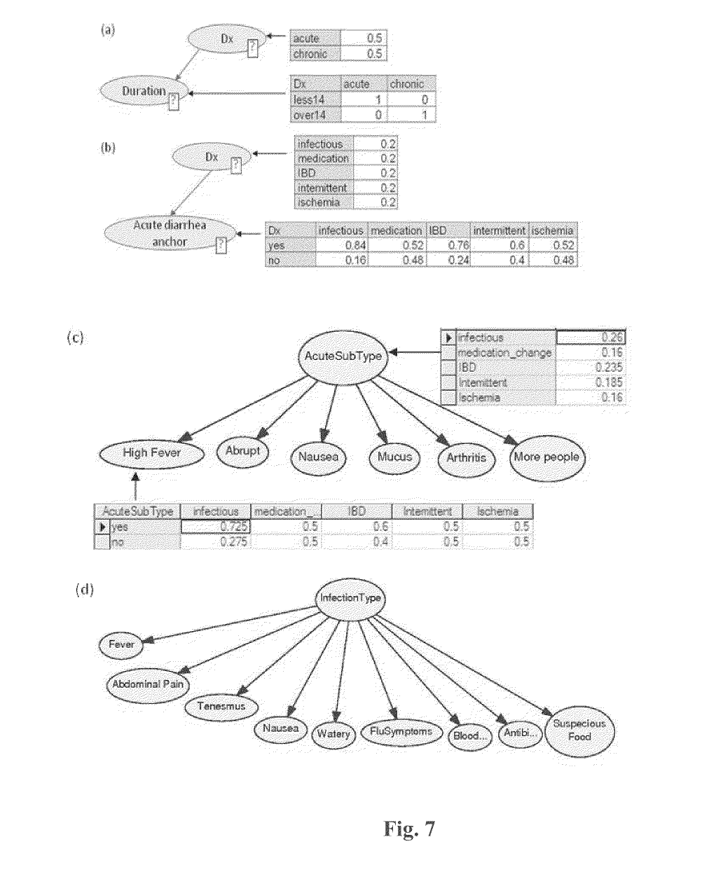

To take advantage of the phased model of the DDS of the invention, the knowledge is arranged in sets of small BNs, where each network corresponds to one phase of DDS of the invention's knowledge-base (KB) and includes the relevant findings and disease hypotheses for that phase, the prior probabilities of the disease hypotheses and the conditional probabilities P(F|D). Parts a, c, and d of FIG. 7 show BNs that correspond to the example discussed hereinabove. FIG. 7 shows Bayesian Networks (BN) for the three phases of diagnosis of diarrhea derived from the knowledge represented in Table 2 with uniform prior probabilities of disease hypotheses. (a) Phase 1 BN. The top insert shows the prior probability of the two abstractions: acute and chronic diarrhea. The uniform prior probabilities are shown for illustrative purposes. The bottom insert shows the conditional probabilities of P(F|D); (b) BN for computing prior probabilities of disease hypotheses of phase 2 BN, relying on the “diagnosis manifested as anchor” relationships of Table 2(b); (c) BN corresponding to phase 2. The prior probabilities are those derived by computing the posterior probability based on the BN shown in (b). The conditional probabilities for P(high fever|D) are shown for illustrative purposes; (d) BN corresponding to phase 3. The BN were created using the GeNIe tool (http://genie.sis.pitt.edu/) and reproduced in the figure.

Because the DDS of the invention's model is arranged in diagnostic phases, in the move from a BN of one phase to the BN of the next phase, simply refines the diagnosis without the need to combine the numerical results from previous phases. For example, in phase 1, setting the value of duration to <=14 and updating the model will result in a posterior probability of 1 for acute diarrhea. Given that abstract diagnosis, we proceed to the phase 2 BN whose anchor is acute diarrhea.

To distinguish the main clinical manifestation from other manifestations of a disease, the information contained in the disease_manifested_as_anchor relationships of the DDS of the invention is used to update the values of the posterior probabilities of the disease hypotheses. To do so, another BN is constructed consisting of the diseases (or abstractions) used in the DD-set of a phase and the phase's anchor (see FIG. 7-B). The probabilities used in this network would be the prior probabilities of the diseases. The conditional probabilities relating the anchor to the individual disease hypotheses P(anchor|D) are derived from the disease_manifested_as_anchor relationships. From this small network, the posterior probability for a disease hypothesis can be derived given that the anchor is present. These probabilities can now serve as the prior probabilities for the diseases in the BN composed of the diseases in the DD-set for the phase and all the other findings apart from the MCM as shown in FIG. 7-C.

Using the above Bayesian approach requires having prior probabilities for each disease hypothesis and conditional probabilities for each combination of finding and disease (finding frequencies). In QMR-DT, the prior probabilities were assembled from data compiled by the National Center for Health Statistics on inpatients discharged from short-stay nonfederal hospitals and the conditional probabilities P(F|D) were derived from the QMR frequency data. Preferably, data used by the DDS of the invention is based on EB studies. However, as hereinbelow, many of the required statistical values are not found in the EB sources.

The DDS Diagnosis-Scoring Algorithm

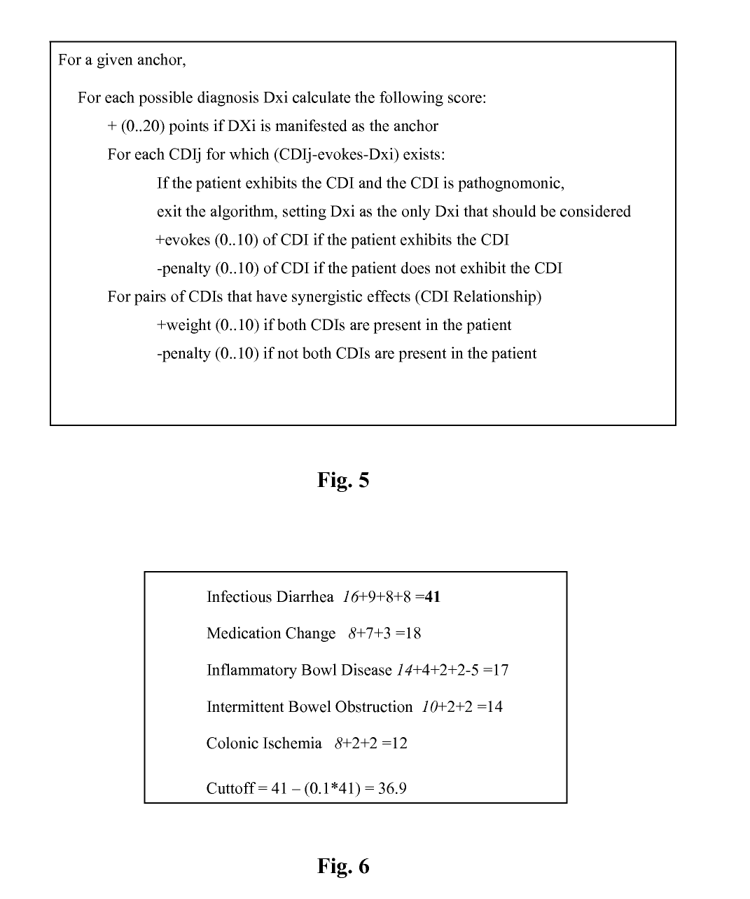

The heuristic scoring algorithm of the DDS of the invention requires the input of fewer probabilities than the Bayesian methods discussed hereinabove. The algorithm, whose pseudo-code is shown in FIG. 5, considers CDIs that suggest a diagnosis with a certain evoking strength. If the CDI is present, then points are awarded according to the evoking strength. If the CDI is considered to be pathogneumonic in evoking the diagnosis, as is sometimes the case for laboratory or imaging findings and very rarely for history and physical examination findings, then that diagnosis would be concluded. If, however, the CDI is not present penalty can be used to deduct points for certain disease hypotheses. The size of the frequency_penalty indicates the likelihood of a hypothesis being inappropriate when a certain CDI is absent.

The last component used for scoring diagnoses is Synergistic_CDI_Relationship_Given_Diagnosis_For_Anchor. When such a relationship is defined and both CDIs are present, points are added to the relevant diagnosis, according to the weight defined for that relationship. If not both CDIs are present, we use selective penalty to deduct points from the diagnosis.

After all the diagnoses in the DD-set are scored, the cutoff—diagnoses are calculated, and the diagnoses that are below the cutoff value do not continue to future steps of the algorithm. In certain embodiments of the invention, the cutoff value is calculated as a value that is 10% lower than the score of the highest ranking diagnosis. The algorithm will suggest the diagnoses that are above the cutoff If a disease hypothesis was selected via a pathogneumonic finding, then no cutoff value is necessary—only that hypothesis is suggested. However, the user may choose to override the recommended diagnosis and select a different diagnosis from the DD-set for the current anchor. The system can then set this diagnosis as the anchor for the next diagnosis phase, taking the information for the appropriate phase from the respective node in the DD-tree. The systems does not allow the user to jump to any node in the DD-tree; if the user has already reached a certain anchor it is interpreted to mean that he has accepted all the abstractions leading to that node. If this is not the case, the user can start another session.

FIG. 6 provides an example of one phase of the algorithm, based on the knowledge shown in FIG. 1. That knowledge was adapted from a medical book based on the principles of evidence-based MCM-oriented diagnosis [Tierney L M, Henderson M. The patient history: evidence-based approach. McGraw-Hill Medical; 2005] and from the infectious diarrhea guideline [Guerrant R L, Gilder T V, Steiner T S, Thielman N M, Slutsker L, Tauxe R V, et al. Practice guidelines for the management of infectious diarrhea. Clin Infect Dis 2001; 32(3):331-51], as explained hereinbelow. The full run of the algorithm can be found in Appendix A. The patient for which the algorithm was executed has been having high fever for 7 days, nausea, vomiting, bloody stools, abdominal pain, and tenesmus. The symptoms appeared abruptly it was not known whether other people had the disease. However, it was known that the following findings are not present: ingestion of suspicious food, mucus, antibiotics, flu-like symptoms, and arthritis.

Examining the score of the first diagnosis, Infectious Diarrhea, it can seen that 16 points (out of 20) were awarded based on the fact that this diagnosis is usually manifested as diarrhea (the anchor), and 9, 8, and 8 points (out of 10 maximum points per finding) were awarded based on the CDI_evokes_diagnosis links between this diagnosis and the following CDIs: fever (high), abrupt presentation, and nausea/vomiting. Note that the relationship of arthritis evokes inflammatory bowel disease with a frequency_penalty of 5 was used to deduct points from that disease hypothesis because arthritis was not present.

Developing a DDS Knowledge Base

In the DDS approach of the invention, which is centered on a MCM, the set of disease hypotheses and CDIs considered at each diagnosis phase as well as the relationships between findings and disease hypotheses depend on the MCM. Therefore, knowledge added to the DDS knowledge base to support diagnosis of a new MCM is independent of the knowledge that already exists in the knowledge base for existing MCMs. This has several consequences. First, phase-specific knowledge usually cannot be reused for different MCMs. For example, while arrhythmias are considered as disease hypothesis for a syncope MCM and for a palpitations MCM, different arrhythmias are considered for each MCM, and with different likelihoods. However, as we advance toward more specific phases in a DD-tree (e.g., bradyarrhythmia), it is more likely that these phases could be reused for the DD-trees of different MCMs. A second consequence of the independence of MCM-oriented diagnostic knowledge is that the addition of knowledge for a new MCM will not affect system performance, because only the DD-tree for that MCM would need to be considered. A third consequence is that the process of developing the DDS knowledge for different MCMs can be done independently and in parallel.

The steps involved in developing the DSS knowledge needed to support diagnosis of a MCM is discussed hereinbelow, addressing the level of effort needed. This is based on our experience in developing the knowledge for the diarrhea MCM and for ongoing development of the syncope MCM. Whenever possible, it was best to elicit disease hypotheses, relevant CDIs, evoking strengths, frequencies of manifestations, weights of diagnosis manifested as anchor, and weights of synergistic relationships based on EB studies. The disease hypotheses that were considered for the diarrhea case and the CDIs used to distinguish between them were based on EB sources [Tierney L M, Henderson M. The patient history: evidence-based approach. McGraw-Hill Medical; 2005; Guerrant R L, Gilder T V, Steiner T S, Thielman N M, Slutsker L, Tauxe R V, et al. Practice guidelines for the management of infectious diarrhea. Clin Infect Dis 2001; 32(3):331-51]; Table 2 shows the disease hypotheses (first column) that were considered and the CDIs (top row) used to differentiate among them.

Some EB studies report probabilities of manifestation of a finding given a disease (frequency). In the DSS of the invention, the important probabilities for the heuristic algorithm are the evoking strengths, i.e., the probabilities of disease given a finding P(D|F) for a given anchor. However, these probabilities are usually not available in evidence-based studies. Bayes law can be used to convert the frequency data into P(D|F) based on the prior probabilities of diseases and of findings per a given anchor. However, the prior probabilities of a finding (per anchor) are difficult to find, and the prevalence of common etiologies of diarrhea in a primary care setting is reported to be unknown in the EB source that we used. Nevertheless, since for a given anchor, a small set of relevant diagnoses (or abstract diagnosis groups) are considered as the DD-set, the frequency numbers P(F|D) were used to select the most relevant diagnosis in the limited DD-set, assuming uniform prior probabilities of diseases (prevalence). In this way, the disease in which the CDIs exhibited by the patient are most frequent is the disease that should be evoked. The frequency numbers were converted to a scale of 0 . . . 10. When ranges were reported, the average was used. Frequency data were provided in the clinical guideline [Guerrant R L, Gilder T V, Steiner T S, Thielman N M, Slutsker L, Tauxe R V, et al. Practice guidelines for the management of infectious diarrhea. Clin Infect Dis 2001; 32(3):331-51.] that was used for the different diseases belonging to the infectious diarrhea abstraction (FIG. 2C). Evoking strength data for the non-infectious acute diarrhea (FIG. 2B) were supplied by experts.

The frequency_penalty used to subtract points in a selective way from a hypothesis when the patient does not exhibit a finding that is manifested in high frequency in a disease, was provided by two clinical experts, who consulted the frequency values reported in the EB studies, but used their expert opinion to decide about the selective penalty (see the Diagnosis-Scoring Algorithm above). These experts also provided numbers for other relationships for which no data were reported in the EB studies: the synergistic effects (scale of 1 . . . 10) and Diagnosis_Manifested_As_Anchor (scale of 1 . . . 20) in the context of diarrhea.

To elicit from experts the frequencies, penalties, and weights for diagnosis manifested as anchor for our preliminary study, Excel tables were prepared such as those shown in tables 2 and 3. The structure of the tables was set based on evidence-based sources and the numbers were supplied by two experts by consensus formulation.

When eliciting such data from experts for a more comprehensive evaluation study, it is suggested to follow the methodology for knowledge base construction based on expert opinion that was proposed by van Ast et al [van Ast J, Talmon J L, Renier W O, Hasman A. An approach to knowledge base construction based on expert opinions. Methods Inf Med 2004; 43(4):427-32]. That methodology suggests starting with a group of experts and calculating the inter-rater interclass correlation coefficient; if it is not large enough, the Spearman-Brown prophecy can be used to predict the number of additional experts.

The effort required to develop the DSS knowledge for a given MCM is considerable. Based on our experience, gathering information from evidence-based sources and arranging it in phases of disease hypotheses and CDIs used to distinguish among them required less effort than acquiring the numbers (which include frequencies, penalties, and weights for diagnosis manifested as anchor) that were not available in the EB studies. Working with the experts requires several iterations; in the first iteration, which spans several sessions, the experts supply all the requested numbers using the tables that were prepared. Then a statistical examination of expert agreement is conducted to see if the numbers could be averaged. As noted above, establishing agreement between experts may require using additional experts. After agreement is established the numbers are entered into the knowledge base and the system's performance on test cases is evaluated, as described in the next section. Fine tuning the knowledge base to support the initial set of test cases requires further iterations with the experts.

### Preliminary Evaluation Studies

The DSS model of the invention was tested and refined by examining the MCM-oriented diagnostic process of diarrhea. As EB sources of medical knowledge, a medical book of problem-oriented diagnosis was used [Tierney L M, Henderson M. The Patient History: Evidence-Based Approach: McGraw-Hill Medical; 2005] and a guideline [Guerrant R L, Gilder T V, Steiner T S, Thielman N M, Slutsker L, Tauxe R V, et al. Practice guidelines for the management of infectious diarrhea. Clin Infect Dis 2001; 32(3):331-51] for diagnosing infectious diarrhea. Screenshots from the DSS model of that guideline are shown in FIGS. 1, 2 and 4. The encoding was validated using the diarrhea test case. An example of the DSS heuristic algorithm run on the diarrhea test case is provided in Appendix A. 8 case vignettes were used to develop and fine-tune the diarrhea knowledge base and 10 additional test cases to validate it, using the heuristic algorithm. All the test cases are presented in Appendix B. The test cases and two of the training set cases were developed by a clinician who was not involved in the development of the DSS and had no knowledge of it. The DSS of the invention produced the expected results for all the test cases. In one test case, the DSS could not differentiate between two diagnoses. The higher-ranking diagnosis (Bacterial diarrhea, non-Shigella) was the correct one, but it received a score that was just one point higher than the diagnosis of Shigellosis. However, even experts find it hard to differentiate these two diagnoses from the presenting clinical data items.

In a study conducted, the knowledge base creation methodology described was used for the clinical problem of Syncope. The algorithm of the invention correctly classified cases taken from the medical literature.

The same test case shown in Appendix A was executed on several diagnostic DSS for broad domains: QMR, DXplain, and GIDEON. The purpose was to see how probabilistic diagnostic DSSs for broad domains perform in supporting the process of an investigation of a clinical problem (e.g., diarrhea). If they would perform well in MCM-oriented diagnosis—a task for which they were not designed—there would not be a need for special-purpose diagnostic DSSs. The results are shown in appendices C, D, and E, respectively. As can be seen, entering a single clinical manifestation (acute diarrhea into QMR and bloody diarrhea into DXplain) produced a DD-set that does not use abstractions but contains concrete diagnoses. In the DD-set, the correct diagnosis (Shigellosis) was not one of the top diagnoses (above 35%) in QMR. In DXplain, it was the fourth diagnosis in the rare disease list. QMR does not guide the user as to what additional data should be collected to distinguish among diagnoses, so we entered the case findings unaided, to refine the DD-set. Once again, Shigellosis was not the top scoring diagnosis. Moreover, the first score in QMR, Toxin-borne diarrhea, ranked extremely low in the DSS of the invention (because it is known that the patient did not ingest suspicious food) and was eliminated by it. Similar results were obtained with DXplain. Although DXplain asked the user about additional findings that may be present, most of them were not relevant to differentiate Shigellosis from the other diagnoses in the DD-set. This strengthens the advantage of the DSS of the invention in supporting efficient investigations of clinical problems.

Running the diarrhea case in GIDEON produced better results than the QMR and DXplain runs. Upon entering the single problem “diarrhea”, the correct diagnosis (Shigellosis) was ranked first. Note that, GIDEON normally prompts the user to input a few other parameters (not just one finding): disease onset time and geographical location. Entering the case's values for these parameters changed the DD; Shigellosis was no longer the top diagnosis. GIDEON did not guide us as to what other finding we should be looking for. After entering the other findings in the test case, GIDEON correctly identified Shigellosis as the top diagnosis, well separating it from the other diagnoses in the DD-set. However, GIDEON contains knowledge just for infectious diseases. Thus, naturally, GIDEON will not help in diagnosing inflammatory (non infections) or medication-change related diarrhea.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments.

Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

### Appendix A. An Algorithm Run for Diarrhea Using TiMeDDx of the Invention

The patient for which the algorithm was run has been having fever for 7 days, nausea, vomiting, bloody stools, abdominal pain, and tenesmus. The symptoms appeared abruptly and it was not known whether other people had the disease. However, it was known that the following findings are not present: ingestion of suspicious food, mucus, antibiotics, flu-like symptoms, and arthritis.

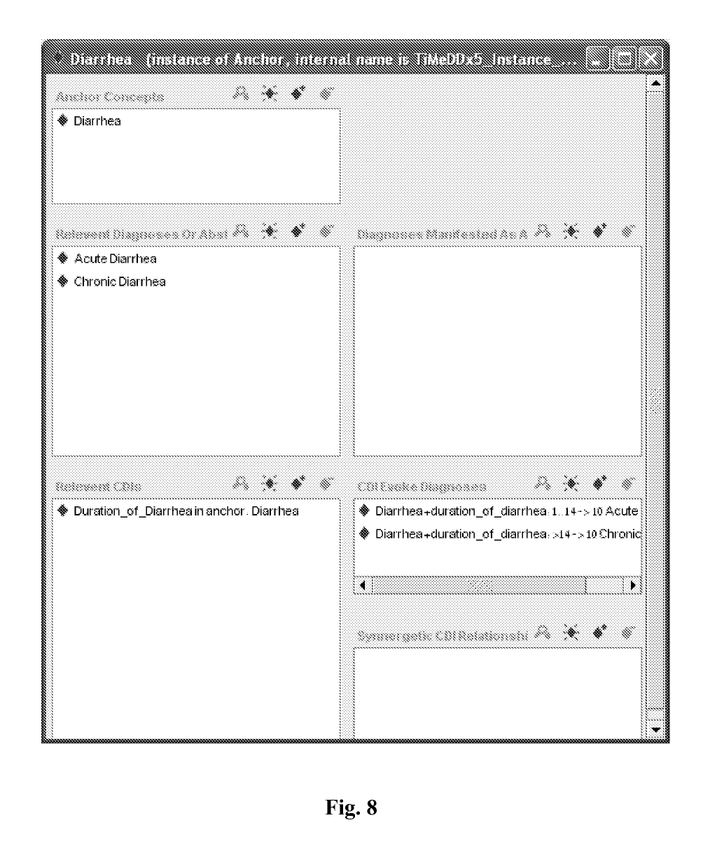

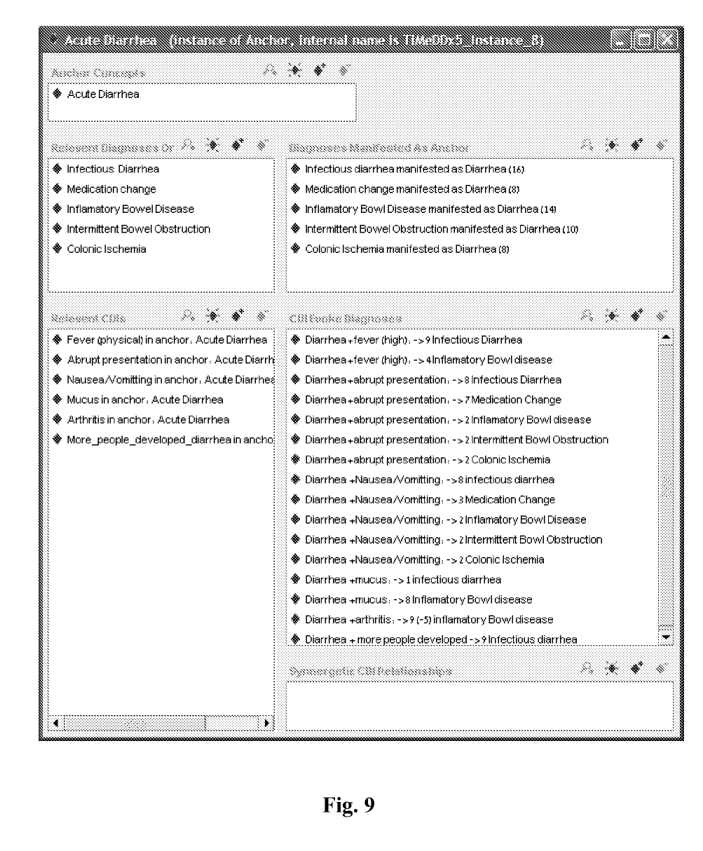

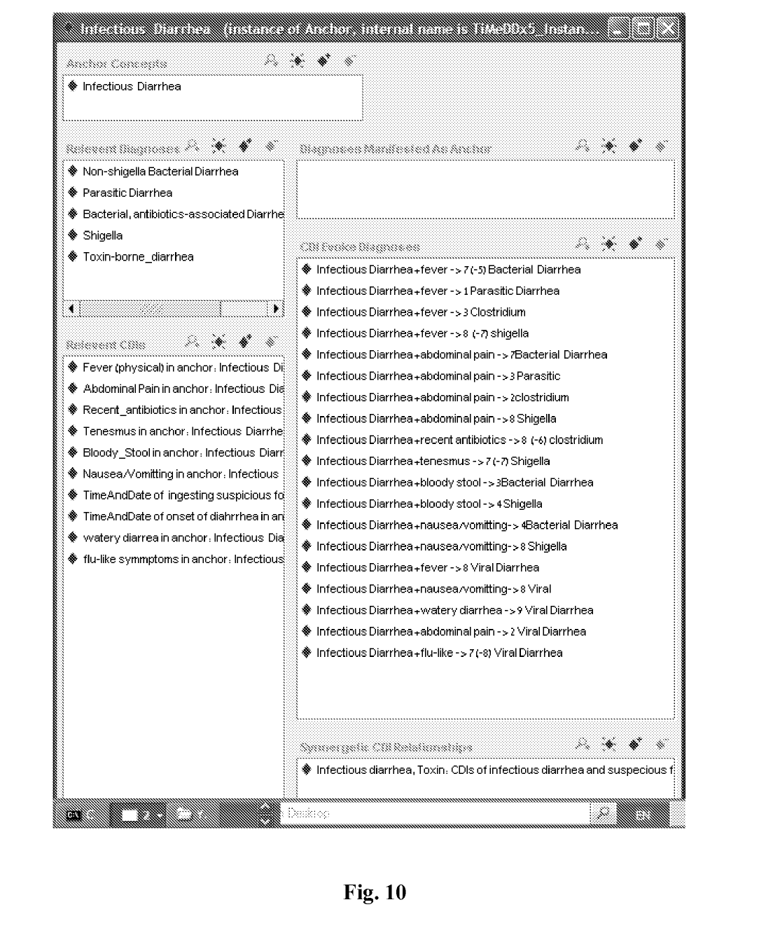

The knowledge in the TiMeDDx knowledge-base of the invention in shown in FIGS. 8-10, showing diagnostic knowledge for the anchors: diarrhea, infectious diarrhea and acute diarrhea.

The algorithm run is executed in three stages. Below, we show the scores given by the algorithm to the different hypotheses. The algorithm is provided and explained in Section 4.

Stage 1:

H1: Acute Diarrhea +10+100=110

H2: Chronic Diarrhea 0

Cutoff is 99

Acute Diarrhea is selected as the new anchor.

Stage 2:

H1.1 Infectious Diarrhea +16+9+8+8=41

H1.2 Medication Change +8+7+3=18

H1.3 Inflammatory Bowl Disease +14+4+2+2−5=17

H1.4 Intermittent Bowel Obstruction +10+2+2=14

H1.5 Colonic Ischemia +8+2+2=12

Cuttoff is 29

Infectious Diarrhea is selected as the new anchor

Stage 3

H1.1.1 Non-shigella Bacterial Diarrhea +7+7+3+4=21

H1.1.2 Parasitic Diarrhea +1+3=4

H1.1.3 Bacterial, antibiotics-associated Diarrhea (Clostridium) +3+2−6=−1

H1.1.4 Shigella 8+8+4+8=28

H1.1.5 Toxin-borne_diarrhea −9

H1.1.6 Viral: 8+2+8−8

Cutoff is 25

Shigella is selected as the final diagnosis

### Appendix B. Test Cases for the Diarrhea Case

### Training set:

Case 1: 7 days diarrhea, high fever, nausea and vomiting, abdominal pain, bloody stools, abrupt presentation, tenesmus, no flu-like, no suspicious food, no antibiotics, no arthritis
Dx: Sigella
Case 2: 26 years old woman, diarrhea and low grade fever for 8 days, mucus secretions, signs of arthritis in the physical examination, no bloody stools, no suspicious food, no antibiotics, no tenesmus
Dx: Inflamatory
Case 3: 65 years old man, hospitalized due to pneumonia, is treated by intravenous antibiotic (cefuroxime), second day of diarrhea, no fever, abdominal pain, no bloody stool, no suspicious food, no antibiotics, no tenesmus
Dx: Clostridium
Case 4: 30 years old man, suffers from diarrhea 12 days, no fever, no antibiotic, no ingestion of suspicious food, no pain, no tenesmus, no bloody stools, no flu-like symptoms
Dx: Parasitic
Case 5: 48 years old woman, 3 days diarrhea, abdominal pain, nausea and vomiting, bloody stool, no tenesmus, no antibiotic, no ingestion of suspicious food, no flu-like symptoms
Dx: Bacterial
Case 6: 27 years old, 5 days diarrhea, abdominal pain, nausea and vomiting, tenesmus, no bloody stools, no fever, no ingestion, no antibiotics, no ingestion of suspicious food, no flu-like
Dx: Shigella
Case 7: 37 years old male, basically healthy, 2 days bloody diarrhea, abdominal pain, fever 38.2 c, no history of antibiotic treatment, no ingestion of suspicious food, no flu-like, no tenesmus
Dx: Shigella
Case 8: 25 years old male, 5 hours of watery diarrhea, abrupt abdominal pain, nausea, no fever, ate at a hamburger place, no antibiotics, no tenesmus, no flu-like
Dx: Food-borne
   Test cases:
Case 9: 70 years old female, 3 days watery diarrhea, abdominal pain, no fever, no nausea, treated in the last week with antibiotic for acute Cellulitis, no ingestion of suspicious food, no tenesmus, no flu-like
Dx—Clostridium
Case 10: 22 years old female, 2 days of watery diarrhea, fever 38 c, cough, headache, abdominal pain, no antibiotic, no ingestion of suspicious food, no tenesmus
Dx—Viral gastroenteritis
Case 11: 32 years old male, volunteered in Sudan, diarrhea for 10 days, no fever, abdominal pain, no bloody stools, no antibiotic, no suspicious food, no tenesmus, no flu-like
Dx—Parasitic
Case 12: 40 years old female, kinder garden teacher, 3 days of diarrhea, bloody, low grade fever, no nausea, abdominal pain, no antibiotic treatment, no suspicious food, no tenesmus, no flu-like
Dx—Bacterial non-shigella
Case 13: 32 years old male, 3 days of bloody diarrhea 15 times per day, 39 c fever, very strong abdominal pain, nausea and vomiting, tenesmus, no flu-like, no antibiotic, no suspicious food
Dx—Shigella
Case 14: 24 years old female, 6 days diarrhea , no blood, but with rubbery secretions, abdominal pain, nausea but no vomiting, 38.5 c fever, no antibiotic treatment, no suspicious food, no flu-like, no tenesmus
Dx—Bacterial and possibly Shigella
Case 15: 28 years old female, no of history of any illness, 5 days diarrhea, no abdominal pain, no fever, no nausea and vomiting, 10 days ago started antibiotic for urinary tract infection, no tenesmus, no suspicious, no flu-like
Dx—Clostridium
Case 16: 25 years old male, 10 days diarrhea, not bloody, no fever, diffuse abdominal pain, returned from a trip in South America, no tenesmus, no flu-like, no suspicious, no antibiotics
Dx—Parasitic
Case 17: A 42 years old man, 1 day of diarrhea, not bloody, nausea and vomiting, diffuse periodic abdominal pain, no fever, a few hours ago ate at a new fish restaurant, no antibiotics, no flu-like, no tenesmus
Dx—Food borne
Case 18: 26 years old female, 3 days diarrhea, watery not bloody, low grade fever, abdominal pain, running nose, muscle pain, no tenesmus, no antibiotics, no suspicious food
Dx—viral gastroenteritis

### Appendix C. Running QMR for the Diarrhea Case

The case description is provided in Appendix A.
Phase 1:
Searching for Diarrhea in QMR yields the following possible terms:
   Constipation alternating with diarrhea
   diarrhea acute
   diarrhea acute recent exposure Hx
   diarrhea chronic
   diarrhea chronic nocturnal
   diarrhea intermittent
   diarrhea Profuse watery

We chose “diarrhea acute”

We received the following DD (score ranges shown in parentheses)

(36-65%)
Viral Gastroenteritis

(6-35%)
Campylobacter Intestinal
Staphylococcal Gastroenterities (Food Poisoning)
Cryptosporidial Enteritis
Shigellosis
Salmoella Enterocolities (Non Typhi)

Note that Shigella (the correct diagnosis for this case) is not the top ranking diagnosis.

Phase 2:

QMR does not guide the user as to what additional data should be collected to distinguish among diagnoses. In TiMeDDx, when we know that we have acute diarrhea, we acquire from the user the following data: fever (yes), abrupt presentation (yes), nausea/vomitting (yes), mucus (no), ingestion of suspicious food (no), and arthritis (no).
Based on this knowledge, we entered additional findings present into QMR: “vomitting, recent”.

We could not find a term for the abrupt presentation

The following DD was obtained (scores shown in parentheses):
Staphylococcal Scarlet Fever (Toxic Shock Syndrome) (92)
Viral Gatroenteritis (92)
Alcoholic hepatitis (87)
Campylobacter Enteritis (87)
Appendicitis, acute (86)
Leptospirosis Systemic (86)
Cholelithiasis (85)
Cryptosporidial Enteritis (85)
Peritonitis Acute Generalized (85)
Salmoella Enterocolities (Non Typhi) (85)
Shigellosis (85)

Once again, Shigellosis is not the top scoring diagnoses. Comparing to phase 2 of the TiMeDDx run in Appendix A, we can see that QMR does not use abstractions, as used in TiMeDDx (e.g., infectious diarrhea). To compare to phase 3 of the TiMeDDx run, we ran the TiMeDDx algorithm again. Unlike the run shown in Appendix A, this time “bloody stools” and “abdominal pain” were not entered, to match with the QMR run.

Phase 3 of the TiMeDDx algorithm produced the following diagnoses and scores:
Shigella +8+8=16
Non-shigella Bacterial Diarrhea +average(7,4)=5.5
Parasitic Diarrhea +1
Bacterial, antibiotics-associated Diarrhea (Clostridium) +2−8=−6
Toxin-borne diarrhea −18=−18

Comparing phase 3 of TiMeDDx to the QMR DD set, we can see that Shigella, which is the diagnosis chosen by TiMeDDx has a score of 85 (of a maximum of 92) in QMR. Note that the first score in QMR, Toxin-borne diarrhea, ranks extremely low in TiMeDDx (because it is known that the patient did not ingest suspicious food) and is eliminated by it.

Using QMR, We can continue the diagnostic process by using QMR's functions for rule out/in different diagnoses in the DD by looking at what other findings are suggested by a hypothesis and what test could be ordered to check for existence of that finding. For example, checking for enteropathogenic bacteria by doing a feces culture, or checking for existence of cholic or diarrhea profuse watery.

### Appendix D. Running DXplain for the Diarrhea Case

Entered: Diarrhea, male, age 18-40, duration 2-7 days

DD: there was insufficient information to support this diagnosis, as none of the diseases were well supported.
Rotarovirus Gastroenteritis
Gastroenteritis, viral
Diverticulitis
Influenza
Diabetes Mellitus, type I
Adverse effects of Medication
Colon, diverticulitos
Food alergy
Gastritis, acute
Adenovirus infection

Note that the correct diagnosis was not in the DD-set

DXplain suggested acquiring the following additional data:
Abdominal tenderness, left lower quadrant
Abdominal pain, left lower quadrant
Glycosuria
Ketoacidosis, diabetic

We added “Abdominal pain, left lower quadrant”

The following DD, once again did not include the correct diagnosis. There was enough information entered to conclude just the top diagnosis on the list.
Diverticulitis
Colon, diverticulitis
Irritable bowl movement
Diabetes Mellitus, type I
Adverse effects of Medication
Food allergy
Gastritis, acute
Gastritis, viral
Influenza

Dxplain lets the user refine the finding of diarrhea before running the diagnosis algorithm. We picked “bloody diarrhea”, obtaining the following DD. There was enough information entered to conclude just the top diagnosis on the common diagnosis list and none of the rare diseases. This time, the correct diagnosis was the 4^{th} item on the rare diseases list.

Common diseases:
Cholitis, ulceritive
Colon, diverticulitis
Camphylobacter enteritis
Food poisoning, Salmonella
Enterocolitis, pseudomembraneous acute
Colon carcinoma
Chron's disease
Food allergy
Rotarovirus Gastroenteritis
Gastroentritis, viral

Rare diseases:
Amebiasis
Hemolytic uremic syndrome
Mercury poisoning, acute
Shigellosis
Invasive E. Coli
Ricin poisoning

DXplain suggested other findings that could be entered. The relevant one was blood in stools, gross. Receiving the following DD-set:

Common diseases:
Cholitis, ulceritive
Colon carcinoma
Colon, diverticulitis
Hemorroids
Enterocolitis, pseudomembraneous acute
Camphylobacter enteritis
Food poisoning, Salmonella
Chron's disease
. . .

Rare diseases:
Lynch syndrome
Amebiasis
Mesenteric vascular insuffeciency, acute
Ricin poisoning
Gardner Syndrome
Hemolytic uremic syndrome
Mercury poisoning, acute
Shigellosis
. . .

This time, the first three diagnoses in the common diseases list and the first one in the rare diseases list were supported by enough data. The correct diagnosis was found in the rare diseases list, this time, at number 8.

In TiMeDDx, when we know that we have acute diarrhea, we acquire from the user the following data: fever (yes), abrupt presentation (yes), nausea/vomitting (yes), bloody stools (yes), mucus (no), ingestion of suspicious food (no), and arthritis (no).

Based on this knowledge, we entered additional findings present into DXplain:

“fever”, “sudden onset of symptoms”, “vomiting”, and “stool blood”.

The following DD-set, included the correct diagnosis (shigellosis) as the third diagnosis in the rare diseases list.

Common diseases:
Cholitis, ulceritive
Colon carcinoma
Crohn's disease
Rotarovirus Gastroenteritis
Food poisoning, Salmonella
Camphylobacter enteritis
Enterocolitis, pseudomembraneous acute
Colon, diverticulitis
Gastritis, acute
Intestine obstruction

Rare diseases:
Lynch syndrome
Ricin poisoning
Shigellosis
Vibrio parahaemoliticus infection
Hemolytic uremic syndrome
Mercury poisoning, acute
Invasive E. Coli
. . .

This time, the first four diagnoses in the common diseases list and the first one in the rare diseases list were supported by enough data. The correct diagnosis was not found in the rare or common diseases list.

To conclude, DXplain included the correct rare diagnosis in its DD-set only when the diagnosis started with a finding that was less abstract than diarrhea (diarrhea, bloody). The correct diagnosis was not the top-most disease in the rare diseases set.

### Appendix E. Running GIDEON for the Diarrhea Case

The case description is provided in Appendix A.

Phase 1:

Diarrhea is entered.

GIDEON produces the following diagnosis:
Shigelloseis (34.3%)
Salmonellosis (24.6%)
Campylobacteriosis (18.5%)
E. Coli Diarrhea (10.3%)
Staphylococcal food poisoning (2%)
Giardiasis (1.9%)
Rotavirus infection (1.9%)

Note that the top diagnosis is the correct one: Shigellosis.

However, GIDEON normally prompts the user to input a few other parameters (not just one finding): disease onset time and geographical location

We entered the time frame of a week ago with location being the US, and received the following DD set:
Campylobacteriosis (38.9%)
E. Coli Diarrhea (21.6%)
Salmonellosis (9.7%)
HIV infection—initial illness (4.7)
Staphylococcal food poisoning (4.1%)
Shigelloseis (4.1%)
Rotavirus infection (3.9%)
Giardiasis (3.9%)
Respiratory viruses (miscellaneous) (3.5%)
Amoeba colitis (1.2%)

Now the correct diagnosis is only at #6

The case description contained additional data. Therefore, we entered:
Fever for 7 days, vomiting, bloody stools, abdominal pain
Could not enter “nausea”
Entered finding not present: ingestion of food
Could not enter lack of: mucus, and arthritis.

Now Shigella is identified as the top ranking diagnosis, well-differentiated from the other diagnoses in the DD-set.
Shigelloseis (83.7%)
E. Coli Diarrhea (4.3%)
Plesiomonas infection (3.5%)
Campylobacteriosis (3.5%)
Salmonellosis (2.9%)
Vibrio parahaemoliticus infection (1%)

But note that GIDEON did not instruct us regarding what data we should be collecting during the diagnostic process.

1. A computerized medical diagnosis method for assisting a health professional to diagnose a medical condition, comprising the steps of:
(i) providing an anchor condition;
(ii) associating with said anchor condition a plurality of diagnoses whose main clinical manifestation is said anchor condition;
(iii) associating with each diagnosis of said plurality of diagnoses a weight that represents the likelihood that the diagnosis is manifested as the anchor condition;
(iv) associating a plurality Clinical Data Items (CDIs) with each diagnosis of said plurality of diagnoses given an anchor condition, each combination of CDI and a diagnosis is assigned an evoking strength in which the CDI evokes the diagnosis and a penalty that the diagnosis receives in the absence of a finding;
(v) calculating a total weighted score for each possible diagnosis of the patient among the plurality of diagnoses by adding for each diagnosis: the likelihood that the diagnosis is manifested as the anchor, the evoking strengths of each CDI that is true for the patient and subtracting for each CDI that is absent in the patient the penalty weight for defined penalty relationships between the diagnosis and the CDIs;
(vi) choosing a diagnosis above a cutoff level of the weighted score and making it an anchor condition; and
(vii) repeating steps (ii) through (vi) until the diagnosis with the highest weighted score, which now serves as an anchor condition, does not have any associated diagnoses and is thus determined to be the diagnosis for said medical condition.

2. A medical diagnosis method according to claim 1, wherein the anchor condition is a symptom, a sign, a laboratory test result, an imaging test results or any combination thereof.

3. A medical diagnosis method according to claim 1, further comprising the step of suggesting clinical data items, laboratory, and imaging tests that should be collected in order to differentiate among alternative diagnoses.

4. A medical diagnosis method according to claim 1, further comprising the step of listing and ranking possible diagnoses of said medical condition.

5. A medical diagnosis method according to claim 1, further comprising a preliminary step of creating a knowledge base for medical conditions and their associated main clinical manifestations (MCMs).

6. A medical diagnosis method according to claim 1, further comprising the step of indicating the probability of occurrence of a MCM given a disease.

7. A medical diagnosis method according to claim 1, wherein combinations of two or more CDIs occurring together or in a certain temporal pattern, favor a certain diagnosis over the additive contribution of each one of the CDIs alone.

8. A medical diagnosis method according to claim 1, wherein when the patient does not exhibit a CDI that is frequent in a disease hypothesis, points are deducted from that hypothesis.

9. A medical diagnosis method according to claim 1, wherein in step (vi) a user overrides a recommended diagnosis above the cutoff level of the weighted score and select instead a different diagnosis and make it an anchor condition.

10. A computerized medical diagnosis method for assisting a health professional to diagnose a medical condition assuming findings are conditionally independent given any disease hypothesis comprising the steps of:
(i) providing an anchor condition;
(ii) associating with said anchor condition a plurality of diagnoses whose main clinical manifestation is said anchor condition;
(iii) arranging the knowledge about a disease in sets of small Bayesian Networks (BNs), wherein each BN corresponds to one phase of a disease Knowledge-Base (KB) and comprises the relevant findings and disease hypotheses for that phase, the prior probabilities of the disease hypotheses and the conditional probabilities P(F|D) representing frequency data;
(iv) moving from the BN of one phase to the BN of the next phase by setting the diagnosis with the highest posterior probability from the prior phase as the anchor of the BN corresponding to the next phase, wherein the prior probabilities of the diagnoses belonging to the next phase given the anchor are computed by constructing an intermediate BN comprising of the diseases or abstractions used in the DD-set of a phase and the phase's anchor condition such that the probabilities used in said intermediate BN are the prior probabilities of the diseases, and the conditional probabilities relating the anchor condition to the individual disease hypotheses P(anchor|D) are derived from the disease manifested as anchor relationships, and the computed prior probabilities of said intermediate BN serve as the prior probabilities for the diseases in the BN of the next phase;
(v) repeating step (iv) until the diagnosis with the highest posterior probability does not serve as an anchor of a next BN and is thus determined to be the diagnosis for said medical condition.

11. A computerized medical diagnosis system for assisting a health professional to diagnose a medical condition, comprising:
(i) means for providing an anchor condition;
(ii) means for associating with said anchor condition a plurality of diagnoses whose main clinical manifestation is said anchor condition;
(iii) means for associating with each diagnosis of said plurality of diagnoses a weight that represents the likelihood that the diagnosis is manifested as the anchor condition;
(iv) means for associating a plurality Clinical Data Items (CDIs) with each diagnosis of said plurality of diagnoses for a given anchor condition, each combination of CDI and a diagnosis is assigned an evoking strength in which the CDI evokes the diagnosis and a penalty that the diagnosis receives in the absence of a finding;
(v) means for calculating a total weighted score for each possible diagnosis of the patient among the plurality of diagnoses by adding for each diagnosis:
the likelihood that the diagnosis is manifested as the anchor, the evoking strengths of each CDI that is true for the patient and subtracting for each CDI that is absent in the patient the penalty weight for defined penalty relationships between the diagnosis and the CDIs;
(vi) means for choosing a diagnosis above a cutoff level of the weighted score and making it an anchor condition; and
(vii) means for repeating steps (ii) through (vi) until the diagnosis with the highest weighted score, which now serves as an anchor condition, does not have any associated diagnoses and is thus determined to be the diagnosis for said medical condition.

12. A medical diagnosis system according to claim 11, wherein the anchor condition is a symptom, a sign, a laboratory test result, an imaging test results or any combination thereof.

13. A medical diagnosis system according to claim 11, wherein clinical data items, laboratory, and imaging tests suggested that should be collected in order to differentiate among alternative diagnoses.

14. A medical diagnosis system according to claim 11, possible diagnoses of said medical condition are listed and ranked.

15. A medical diagnosis system according to claim 11, wherein a knowledge base for medical conditions and their associated main clinical manifestations is first created.

16. A medical diagnosis system according to claim 11, wherein the probability of occurrence of a MCM given a disease is indicated.

17. A medical diagnosis system according to claim 11, wherein in step (vi) a user overrides a recommended diagnosis above the cutoff level of the weighted score and select instead a different diagnosis and make it an anchor condition.

18. A computer-readable medium encoded with a program module that executes a medical diagnosis method for assisting a health professional to diagnose a medical condition, by:
(i) providing an anchor condition;
(ii) associating with said anchor condition a plurality of diagnoses whose main clinical manifestation is said anchor condition;
(iii) associating with each diagnosis of said plurality of diagnoses a weight that represents the likelihood that the diagnosis is manifested as the anchor condition;
(iv) associating a plurality Clinical Data Items (CDIs) with each diagnosis of said plurality of diagnoses given an anchor condition, each combination of CDI and a diagnosis is assigned an evoking strength in which the CDI evokes the diagnosis and a penalty that the diagnosis receives in the absence of a finding;
(v) calculating a total weighted score for each possible diagnosis of the patient among the plurality of diagnoses by adding for each diagnosis: the likelihood that the diagnosis is manifested as the anchor, the evoking strengths of each CDI that is true for the patient and subtracting for each CDI that is absent in the patient the penalty weight for defined penalty relationships between the diagnosis and the CDIs;
(vi) choosing the diagnosis above a cutoff level of the weighted score and making it an anchor condition; and
(vii) repeating steps (ii) through (vi) until the diagnosis with the highest weighted score, which now serves as an anchor condition, does not have any associated diagnoses and is thus determined to be the diagnosis for said medical condition.
